(19) United States
(12) Patent Application Publication
(10) Pub. No.: US 2019/0230253 A1
(43) Pub. Date: Jul. 25, 2019

(54) FACE TONE COLOR ENHANCEMENT

(71) Applicant: QUALCOMM Incorporated, San Diego, CA (US)

(72) Inventors: Soman Nikhara, Hyderabad (IN); Ho Sang Lee, San Diego, CA (US); Wei-Chih Liu, Taipei City (TW)

(21) Appl. No.: 15/877,927

(22) Filed: Jan. 23, 2018

(51) Int. Cl. H04N 1/60

(52) U.S. Cl. CPC H04N 1/6027; H04N 1/6008

(57) ABSTRACT

Methods, systems, and devices for color enhancement are described. A device may receive a raw image from a sensor (e.g., a camera of the device). The device may detect multiple regions of pixels corresponding to different image features in the raw image. For example, each region of pixels may correspond to one or more facial features. The device may compute one or more color ratios for each region of pixels. The device may then determine a respective color correction matrix for each region of pixels based at least in part on the one or more color ratios associated with that region of pixels. The device may generate a color-corrected image based on applying the respective color correction matrix to each region of pixels and may output the color-corrected image (e.g., to a display of the device, to a system memory, etc.).

### BACKGROUND

The following relates generally to color enhancement, and more specifically to face tone color enhancement.

Spectral responses of human eyes and spectral responses of digital sensors (e.g., cameras) and/or displays may be different. Thus, colors obtained by a digital sensor may differ from colors perceived by humans. Devices may use image processing techniques to convert image data (e.g., Bayer data) to various color formats and may perform various enhancements and modifications to the raw image. For example, a device may apply a global color correction matrix (CCM) to the raw image to attempt to better reproduce the true colors in a scene. However, because of differing color tones within the scene, the global CCM may in some cases generate inaccurate representations of the scene. Improved techniques for color enhancement of an image may be desired.

### SUMMARY

The described techniques relate to improved methods, systems, devices, or apparatuses that support face tone color enhancement. Generally, the described techniques provide for accurate skin color tone reproduction in an image. Though aspects of the following are described in the context of facial features, it is to be understood that the described techniques may additionally or alternatively be applicable to skin tones in general or to other (e.g., non-skin tone related) features of a scene. By way of example, any image feature (e.g., trees in a landscape scene, clothing fabric, etc.) which may be reliably extracted from an image may be processed using aspects of the techniques described below. A device, such as a wireless device, may compute one or more local color correction matrices (CCMs) for an image. For example, each CCM may be based on one or more color ratios associated with a given region of pixels. The device may apply a respective CCM to each region of pixels (e.g., using hardware or software). In some cases, the local CCMs may additionally remove the effects of any global CCM (e.g., which may be applied by hardware during an early stage of the image processing operation). By way of example, the described techniques may improve face skin tone image quality by helping to reproduce the true face color tone.

A method of color enhancement is described. The method may include receiving a raw image from a sensor of the device, detecting a plurality of regions of pixels corresponding to respective image features in the raw image, computing one or more color ratios for each region of pixels, determining a respective CCM for each region of pixels based at least in part on the one or more color ratios associated with that region of pixels, generating a color-corrected image based on an application of the respective CCM to each region of pixels, and outputting the color-corrected image.

An apparatus for color enhancement is described. The apparatus may include means for receiving a raw image from a sensor of the device, means for detecting a plurality of regions of pixels corresponding to respective image features in the raw image, means for computing one or more color ratios for each region of pixels, means for determining a respective CCM for each region of pixels based at least in part on the one or more color ratios associated with that region of pixels, means for generating a color-corrected image based on an application of the respective CCM to each region of pixels, and means for outputting the color-corrected image.

Another apparatus for color enhancement is described. The apparatus may include a processor, memory in electronic communication with the processor, and instructions stored in the memory. The instructions may be operable to cause the processor to receive a raw image from a sensor of the device, detect a plurality of regions of pixels corresponding to respective image features in the raw image, compute one or more color ratios for each region of pixels, determine a respective CCM for each region of pixels based at least in part on the one or more color ratios associated with that region of pixels, generate a color-corrected image based on an application of the respective CCM to each region of pixels, and output the color-corrected image.

A non-transitory computer-readable medium for color enhancement is described. The non-transitory computer-readable medium may include instructions operable to cause a processor to receive a raw image from a sensor of the device, detect a plurality of regions of pixels corresponding to respective image features in the raw image, compute one or more color ratios for each region of pixels, determine a respective CCM for each region of pixels based at least in part on the one or more color ratios associated with that region of pixels, generate a color-corrected image based on an application of the respective CCM to each region of pixels, and output the color-corrected image.

In some examples of the method, apparatus, and non-transitory computer-readable medium described above, computing the one or more color ratios for each region of pixels comprises determining respective statistics for a plurality of sections of the raw image, wherein the statistics for a given section indicate one or more representative pixel values for the given section. Some examples of the method, apparatus, and non-transitory computer-readable medium described above may further include processes, features, means, or instructions for identifying, for each region of pixels, one or more sections of the raw image containing the each region of pixels. Some examples of the method, apparatus, and non-transitory computer-readable medium described above may further include processes, features, means, or instructions for computing the one or more color ratios for each region of pixels based at least in part on the statistics for the one or more sections of the raw image which contain that region of pixels.

In some examples of the method, apparatus, and non-transitory computer-readable medium described above, determining the respective CCM for each region of pixels comprises identifying a white balance output for the raw image based at least in part on the statistics. Some examples of the method, apparatus, and non-transitory computer-readable medium described above may further include processes, features, means, or instructions for determining values for each respective CCM based at least in part on the white balance output.

In some examples of the method, apparatus, and non-transitory computer-readable medium described above, determining values for each respective CCM based at least in part on the white balance output comprises identifying a range of color ratios associated with each of a plurality of template color correction matrices based at least in part on the white balance output. Some examples of the method, apparatus, and non-transitory computer-readable medium described above may further include processes, features, means, or instructions for identifying, for each region of pixels, a respective template CCM based at least in part on a color ratio of the one or more color ratios for that region of pixels falling within the range of color ratios associated with that template CCM. Some examples of the method, apparatus, and non-transitory computer-readable medium described above may further include processes, features, means, or instructions for determining values for each respective CCM based at least in part on the respective template CCM.

In some examples of the method, apparatus, and non-transitory computer-readable medium described above, the plurality of sections collectively comprise an entirety of the raw image, the statistics for the given section indicating an average red component value for the given section, an average blue component value for the given section, an average green component value for the given section, or a combination thereof.

In some examples of the method, apparatus, and non-transitory computer-readable medium described above, detecting the plurality of regions of pixels corresponding to respective image features in the raw image comprises detecting a plurality of faces in the raw image based at least in part on one or more respective facial features associated with each face.

In some examples of the method, apparatus, and non-transitory computer-readable medium described above, computing the one or more color ratios for each region of pixels comprises computing a respective red-to-green ratio, a respective blue-to-green ratio, or both for each region of pixels.

In some examples of the method, apparatus, and non-transitory computer-readable medium described above, determining the respective CCM for a given region of pixels comprises identifying a first template CCM having a first color ratio lower than a corresponding color ratio of the one or more color ratios for the given region of pixels. Some examples of the method, apparatus, and non-transitory computer-readable medium described above may further include processes, features, means, or instructions for identifying a second template CCM having a second color ratio greater than the corresponding color ratio of the one or more color ratios for the given region of pixels. Some examples of the method, apparatus, and non-transitory computer-readable medium described above may further include processes, features, means, or instructions for interpolating between values of the first template CCM and the second template CCM to generate values of the respective CCM for the given region of pixels.

### BRIEF DESCRIPTION OF THE DRAWINGS

FIG. 1 illustrates an example of a digital image that supports face tone color enhancement in accordance with aspects of the present disclosure.

FIG. 2 illustrates an example of a device that supports face tone color enhancement in accordance with aspects of the present disclosure.

FIG. 3 illustrates an example of a wireless communications system that supports face tone color enhancement in accordance with aspects of the present disclosure.

FIG. 4 illustrates an example of a process flow that supports face tone color enhancement in accordance with aspects of the present disclosure.

FIG. 5 shows a block diagram of a device that supports face tone color enhancement in accordance with aspects of the present disclosure.

FIGS. 6 and 7 illustrate methods for face tone color enhancement in accordance with aspects of the present disclosure.

### DETAILED DESCRIPTION

Accurate reproduction of the true color(s) in a scene may be based on accurate white balance output and color correction. The white balance output may be based on the lighting conditions (e.g., illuminant value). Color correction may, in turn be based on the white balance output. That is, an image processor may be operable to select between multiple sets of color correction parameters based on the white balance output. By way of example, a set of outdoor color correction parameters may be selected if the white balance output indicates a daylight setting (e.g., an illuminant value of D75, D65, D50, Noon, etc.) while a set of indoor color correction parameters may be selected if the white balance output indicates an indoor setting (e.g., an illuminant value of fluorescent illuminant (TL84), CW, tungsten (A), etc.). However, for scenes with a variety of tones (e.g., an image containing multiple faces), a single set of color correction parameters may not be able to accurately reproduce all of the tones in the image. That is, in such a multiple-face scenario (e.g., where the face color tone can vary from light to dark skin), some white balance solutions may produce only a single CCM (e.g., which may reproduce one of the multiple faces correctly but not the others because of the different tone patterns).

By way of example, different face tones may have different color ratios. For example, a first face tone may have a red component to green component (RG) ratio of 1.3197 and a blue component to green component (BG) ratio of 0.7831. A second face tone may have a RG ratio of 1.5211 and a BG ratio of 0.6564. Thus, the variance in color ratios between different tones may be significant (e.g., roughly 25%). If an appropriate global CCM is selected for the first face tone, the second face tone may not be accurately displayed in the image. Aspects of the present disclosure relate to techniques for accurate reproduction of face color in a multiple face scenario (i.e., an image containing multiple faces). Though described in the context of faces and face tones, it is to be understood that the described techniques may be applied to other situations (e.g., skin tones in general, multiple tones in a landscape image, different buildings in an urban image, etc.) without deviating from the scope of the present disclosure.

Aspects of the disclosure are initially described in the context of a digital image. Aspects of the disclosure are then illustrated in the context of a device diagram, a wireless communications system, and a process flow. Aspects of the disclosure are further illustrated by and described with reference to an apparatus diagrams and flowcharts that relate to face tone color enhancement.

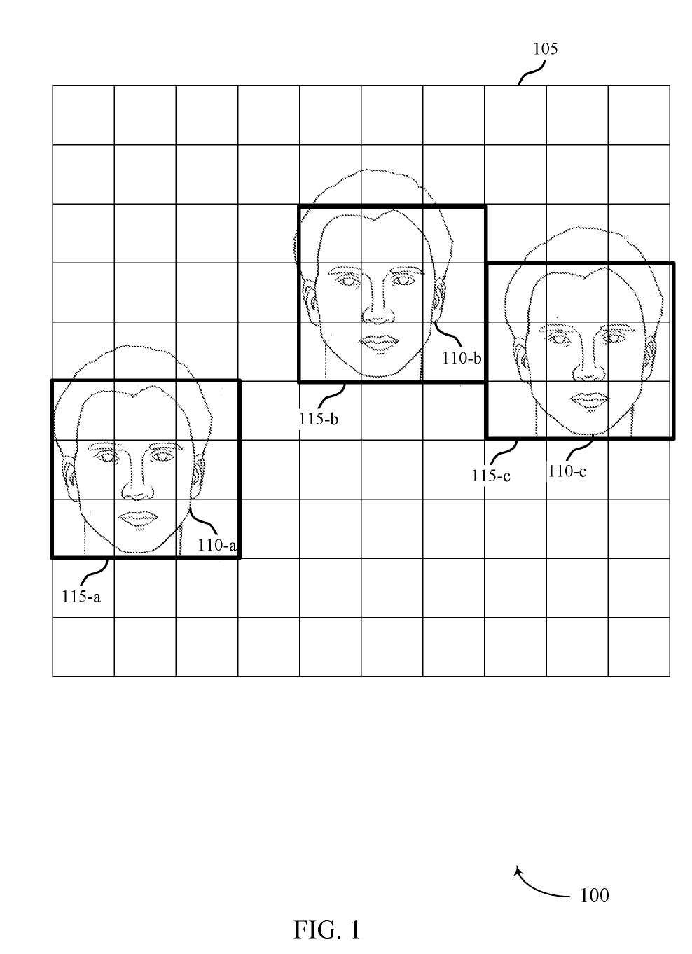

FIG. 1 shows an example of a digital image 100 comprising a plurality of pixels 105. Digital image 100 is included for the sake of illustration and may not be drawn to scale. Digital image 100 includes three faces 110, each occupying a respective region of pixels 115.

In some examples, each face 110 may be associated with a respective skin tone. By way of example, face 110-a may be associated with a first skin tone (e.g., having a RG ratio of 0.5 and a BG ratio of 0.75). Similarly, face 110-b may be associated with a second skin tone (e.g., having a RG ratio of 0.9 and a BG ratio of 1.1), and face 110-c may be associated with a third skin tone (e.g., having a RG ratio of 0.8 and a BG ratio of 0.75). It is to be noted that these component color ratios are included for the sake of illustration and may not be representative of actual skin tone color ratios.

An image processor which applies a global CCM to digital image 100 may not be able to accurately reproduce all three (e.g., or more than one of the) skin tones. That is, a global CCM which accurately reproduces the first skin tone (e.g., by adjusting the red, green, and blue (RGB) components of each pixel of 105 of digital image 100) may inaccurately reproduce the second skin tone and third skin tone.

In accordance with aspects of the following, a device may select a local CCM (e.g., for each region of pixels 115). The local CCM may in some cases be applied on top of (i.e., in addition to) the global CCM and may be adjusted to remove the effects of the global CCM. As described further below, the device may determine an appropriate local CCM for each region of pixels 115 (e.g., based on a white balance decision for digital image 100, a white balance decision for that region of pixels 115, one or more color ratios for that region of pixels, etc.). In some cases, the one or more color ratios for each region of pixels may be based at least in part on a downsampled version of digital image 100. That is, a resolution of digital image 100 may be reduced (e.g., by combining the pixel values for a set of pixels 105 into a single representative value or vector). The downsampled version may be used to compute color ratios for one or more sections of the image (e.g., which may in turn contain faces 110 or portions thereof). By computing color ratios for the downsampled version of digital image 100, a device may conserve processing power and time (e.g., among other benefits). Thus, a first local CCM may be applied to region of pixels 115-a, a second local CCM may be applied to region of pixels 115-b, and a third local CCM may be applied to region of pixels 115-c. For example, the different local CCMs may be obtained from a look-up table (e.g., based on the respective color ratios), may be obtained based on adjusting one or more preconfigured CCMs, may be selected (e.g., based on user input), etc. In aspects of the present disclosure, each region of pixels 115 may be detected using special purpose hardware or software (e.g., a neural network), which may identify facial features and classify pixels 105 into regions of pixels 115 accordingly.

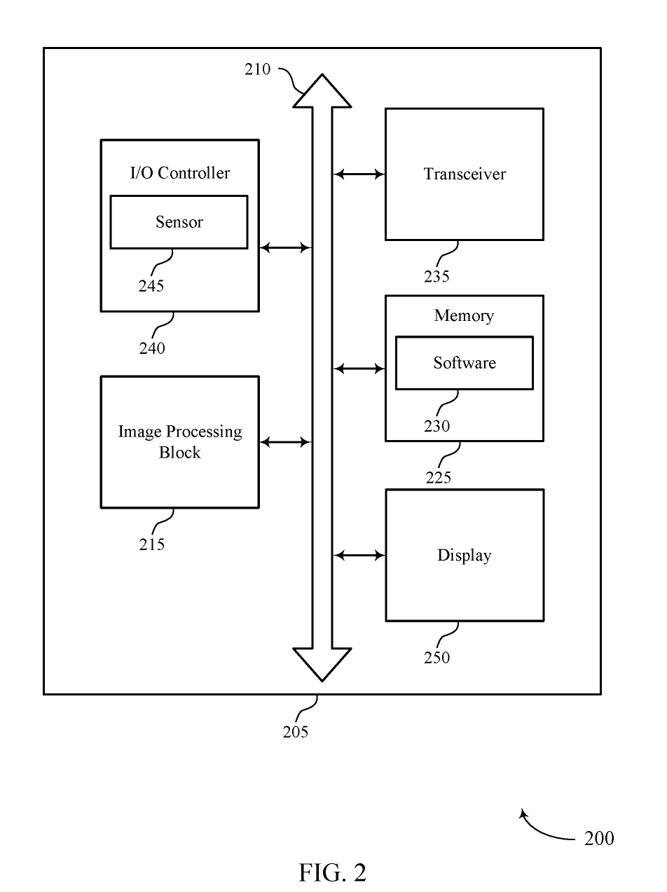

FIG. 2 shows a diagram of a system 200 including a device 205 that supports face tone color enhancement in accordance with aspects of the present disclosure. Device 205 may include components for bi-directional voice and data communications including components for transmitting and receiving communications, including image processing block 215, memory 225, software 230, transceiver 235, I/O controller 240, sensor 245, and display 250. These components may be in electronic communication via one or more buses (e.g., bus 210).

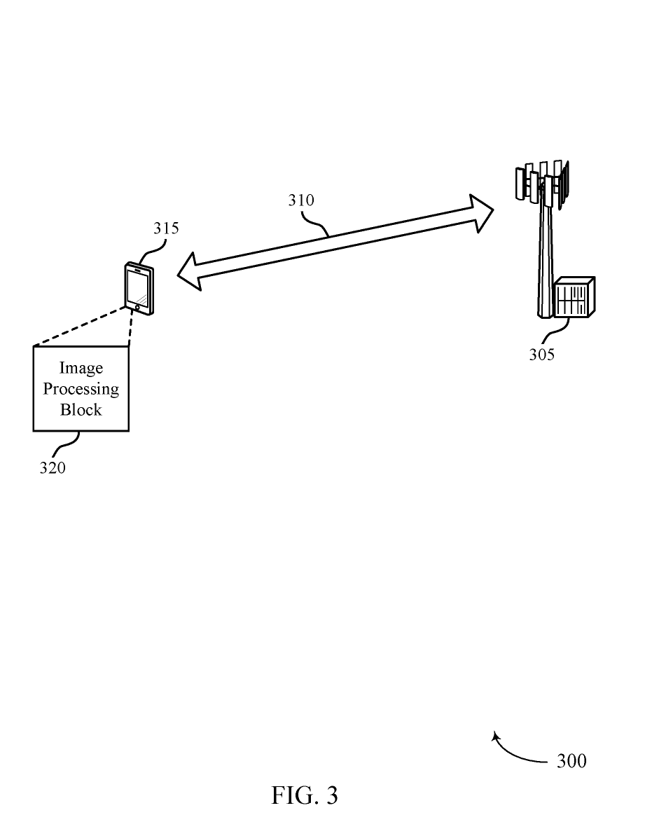

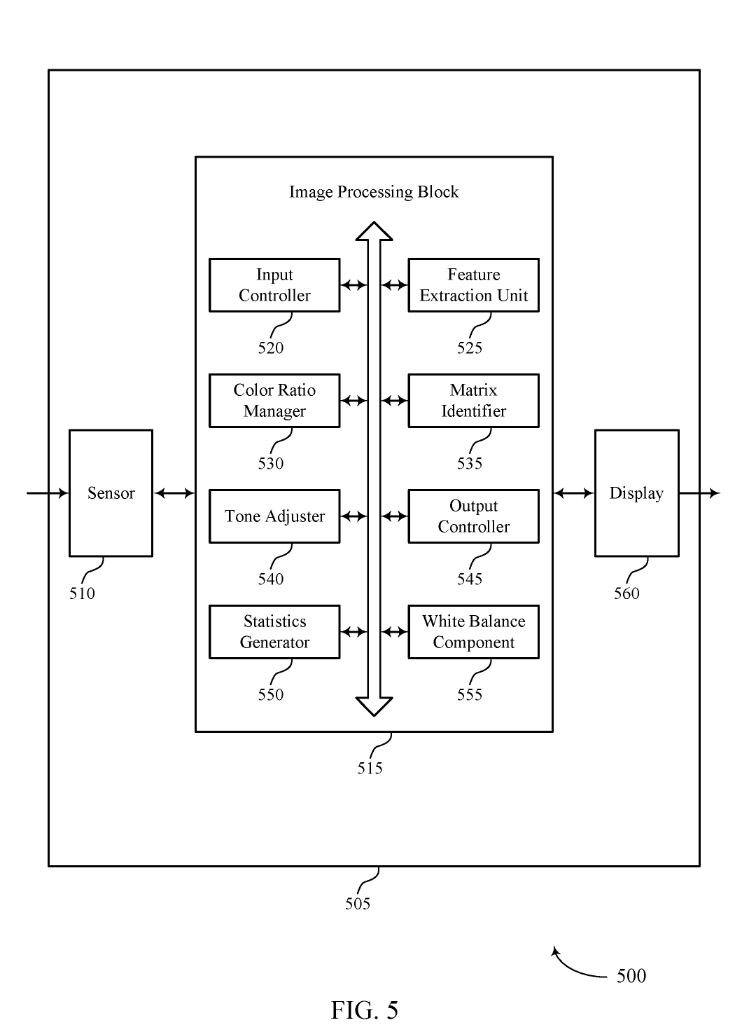

Image processing block 215 may include an intelligent hardware device, (e.g., a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a programmable logic device, a discrete gate or transistor logic component, a discrete hardware component, or any combination thereof). In some cases, image processing block 215 may be configured to operate a memory array using a memory controller. In other cases, a memory controller may be integrated into image processing block 215. Image processing block 215 may be configured to execute computer-readable instructions stored in a memory to perform various functions (e.g., functions or tasks supporting face tone color enhancement). Image processing block 215 may be an example of the corresponding component described with reference to FIGS. 3 and 5. Thus, in some cases, image processing block 215 may compensate for differences between the spectral sensitivities of camera sensors (e.g., sensor 245) and the spectral responses of the human visual system.

Memory 225 may comprise one or more computer-readable storage media. Examples of memory 225 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. Memory 225 may store program modules and/or instructions that are accessible for execution by image processing block 215. That is, memory 225 may store computer-readable, computer-executable software 230 including instructions that, when executed, cause the processor to perform various functions described herein. In some cases, the memory 225 may contain, among other things, a basic input/output system (BIOS) which may control basic hardware or software operation such as the interaction with peripheral components or devices.

Software 230 may include code to implement aspects of the present disclosure, including code to support face tone color enhancement. Software 230 may be stored in a non-transitory computer-readable medium such as system memory or other memory. In some cases, the software 230 may not be directly executable by the processor but may cause a computer (e.g., when compiled and executed) to perform functions described herein.

Transceiver 235 may communicate bi-directionally, via one or more antennas, wired, or wireless links as described above. For example, the transceiver 235 may represent a wireless transceiver and may communicate bi-directionally with another wireless transceiver. The transceiver 235 may also include a modem to modulate the packets and provide the modulated packets to the antennas for transmission, and to demodulate packets received from the antennas.

I/O controller 240 may manage input and output signals for device 205. I/O controller 240 may also manage peripherals not integrated into device 205. In some cases, I/O controller 240 may represent a physical connection or port to an external peripheral. In some cases, I/O controller 240 may utilize an operating system such as iOS®, ANDROID®, MS-DOS®, MS-WINDOWS®, OS/2®, UNIX®, LINUX®, or another known operating system. In other cases, I/O controller 240 may represent or interact with a modem, a keyboard, a mouse, a touchscreen, or a similar device. In some cases, I/O controller 240 may be implemented as part of a processor. In some cases, a user may interact with device 205 via I/O controller 240 or via hardware components controlled by I/O controller 240. In some cases, I/O controller 240 may be or include sensor 245.

Sensor 245 may be an example of a digital imaging sensor for taking photos and video. For example, sensor 245 may represent a camera operable to obtain a raw image (e.g., digital image 100) of a scene, which raw image may be processed by image processing block 215 according to aspects of the present disclosure to generate a color-corrected image.

Display 250 represents a unit capable of displaying video, images, text or any other type of data for consumption by a viewer. Display 250 may include a liquid-crystal display (LCD), a light emitting diode (LED) display, an organic LED (OLED), an active-matrix OLED (AMOLED), or the like. In some cases, display 250 and I/O controller 240 may be or represent aspects of a same component (e.g., a touchscreen) of device 205.

FIG. 3 illustrates an example of a wireless communications system 300 that supports face tone color enhancement in accordance with various aspects of the present disclosure. As illustrated, wireless communications system 300 includes a mobile device 315 in communication with a base station 305 (e.g., via wireless link 310). Mobile device 315 may be an example of device 205 described with reference to FIG. 2. For example, wireless link 310 may be used to communicate data packets. Although illustrated as occurring between base station 305 and mobile device 315, it is to be understood that wireless link 310 may additionally or alternatively support communication between two mobile devices 315, two base stations 305, a mobile device 315 and an external server, etc.

Base station 305 may wirelessly communicate with mobile devices 315 via one or more base station antennas. Wireless link 310 may include uplink transmissions from mobile device 315 to base station 305, or downlink transmissions, from base station 305 to mobile device 315. Base stations 305 in wireless communications system 300 may interface with a core network through backhaul links. Base stations 305 may also communicate with one another over backhaul links, either directly or indirectly. Base stations 305 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 300 may include base stations 305 of different types (e.g., macro or small cell base stations). The mobile devices 315 described herein may be able to communicate with various types of base stations 305 and network equipment including macro eNBs, small cell eNBs, gNBs, relay base stations, and the like.

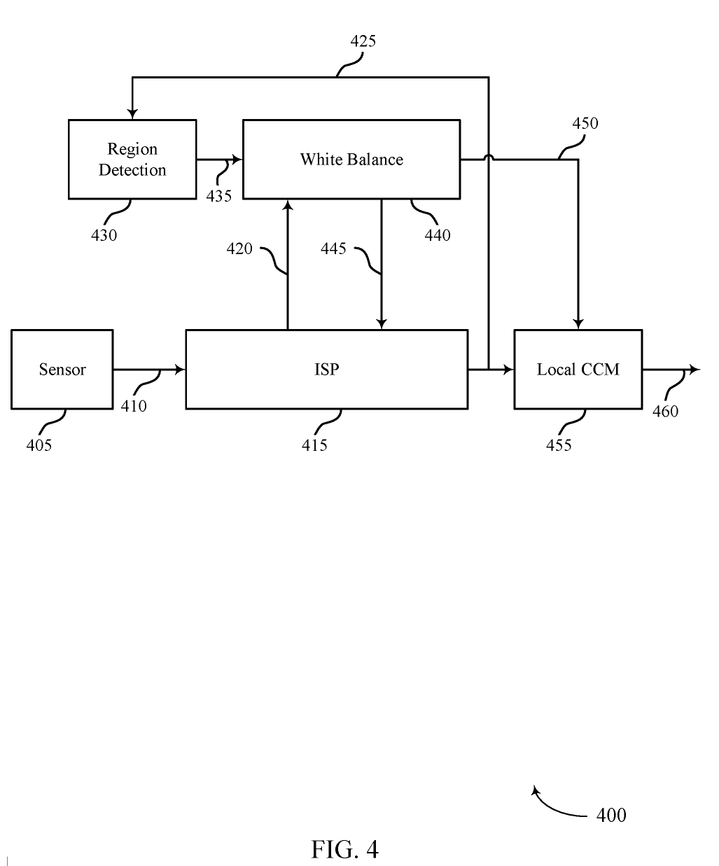

Mobile devices 315 may be dispersed throughout wireless communications system 300, and each mobile device 315 may be stationary or mobile. A mobile device 315 may also be referred to as a user equipment (UE), a wireless device, a remote device, a handheld device, or a subscriber device, or some other suitable terminology, where the “device” may also be referred to as a unit, a station, a terminal, or a client. A mobile device 315 may be a personal electronic device such as a cellular phone, a personal digital assistant (PDA), a tablet computer, a laptop computer, or a personal computer. In some examples, a mobile device 315 may also refer to a wireless local loop (WLL) station, an Internet of Things (IoT) device, an Internet of Everything (IoE) device, a machine type communication (MTC) device, or the like, which may be implemented in various articles such as appliances, vehicles, meters, or the like. or some other suitable terminology. Mobile device 315 may include image processing block 320, which may be an example of image processing block 415 described with reference to FIG. 4. Mobile device 315 may thus support face tone color enhancement, as described further below.

FIG. 4 illustrates an example of a process flow 400 that supports face tone color enhancement in accordance with various aspects of the present disclosure. Process flow 400 (e.g., or portions thereof) may be implemented by device 205 as described with reference to FIG. 2, mobile device 315 as described with reference to FIG. 3, or device 505 as described with reference to FIG. 5.

At 405, a sensor (e.g., a digital image sensor) may capture a raw image of a scene. For example, the sensor may generate a two-dimensional pixel array representing the scene. In some cases, the two-dimensional pixel array may be generated in the Bayer domain (e.g., based on a filter coupled with the photodiodes comprising the sensor).

At 410, the sensor may pass the raw image (e.g., the two-dimensional pixel array) to an ISP. At 415, the ISP may process the raw image. For example, the ISP may compute statistics for the raw image, which statistics may be passed to a white balance component at 420. By way of example, at 415 the ISP may divide the raw image into sections and compute statistics for each section. Dividing the raw image into sections may include downsampling the raw image (e.g., such that a group of pixels in the raw image may be represented by a single set of representative pixel values). For example, at 415 the ISP may compute one or more of a red component, a blue component, a green component, a luma component, etc. for each group of pixels (i.e., each section) and may pass these statistics to a white balance component at 420.

At 440, the white balance component may apply a white balance algorithm to the received statistics for the entire raw image. For example, the white balance algorithm may make a white balance decision for the image and select a global CCM based at least in part on the white balance decision. As an example, the white balance algorithm may (e.g., based on the statistics) determine an illuminant setting (e.g., outdoor, indoor fluorescent, etc.) for a scene. Each illuminant setting may, in some cases, be associated with a given global CCM. At 445, the white balance component may pass the white balance decision and/or global CCM to the ISP, which may in some cases apply the global CCM to the raw image data to generate a filtered image at 425. For example, the global CCM may comprise a 3×3 matrix which may be applied to the 3×1 component vector comprising each pixel (e.g., the red, green, and blue components of each pixel) to generate a filtered 3×1 component vector for each pixel. The filtered image at 425 (e.g., which may comprise the raw image data modified according to the global CCM) may be passed to a region detection component at 430. Additionally or alternatively, the raw image (e.g., the two-dimensional pixel array generated at 405) may be passed to the region detection component. In either case, the region detection component may perform feature extraction (e.g., on the raw image and/or the filtered image) to identify one or more regions of interest in the image. For example, the region detection component may apply a convolutional neural network (CNN) to the image data to detect regions of pixels containing facial features.

At 435, the region detection component may pass the regions of interest to the white balance component. The white balance component may determine color ratios for each region of interest (e.g., by using the statistics received at 420 corresponding to the section(s) which contain the region of interest). The color ratios may then be used to determine an appropriate local CCM for each region of pixels. By way of example, the white balance decision for the raw image (e.g., at 445) may be used to select an appropriate color ratio range for the CCMs. Alternatively, the white balance algorithm may make a local white balance decision for each region of pixels. In some cases, for a given white balance decision (e.g., daylight, fluorescent, incandescent), a color ratio range may be defined. In an example, the device may be configured with four (4) CCMs. For a first white balance decision (e.g., daylight), the color ratio range may specify a first CCM for any color ratios (e.g., which may refer to RG ratio, BG ratio, combinations thereof, or the like) having a value of 0.5, a second CCM for any color ratios having a value of 0.7, etc. For a second white balance decision (e.g., incandescent), the color ratio range may specify the first CCM for any color ratios having a value of 0.3, the second CCM for any color ratios having a value of 0.4, etc. It is to be understood that these numbers are included for the sake of explanation and are not limiting of scope. In some examples, interpolation between CCMs may be performed (e.g., to improve a flexibility of the CCMs). By way of example, for the first white balance decision described above, a region of pixels having a color ratio of 0.6 may be processed using a third CCM that is determined by averaging (e.g., or otherwise interpolating between) values of the first CCM and the second CCM. Additionally or alternatively, the white balance output may be applied (e.g., as a numerical weight) to a given set of CCMs such that a single range of color ratios may be defined for all white balance outputs (e.g., which range may be essentially modified based on applying the numerical weight associated with the white balance output to the given set of CCMs).

At 450, the local CCMs for each region of pixels may be passed from the white balance output to a local CCM applier. For example, the local CCM applier may be a hardware component (e.g., which is interoperable with or a component of the ISP) or may be a software component (e.g., which may be stored in a memory of the device). At 455, the local CCM applier may apply the local CCMs to each region of pixels (e.g., where each local CCM may invert the effects of the global CCM applied by the ISP based on the white balance output at 445). The local CCM applier may output the color-corrected image (e.g., to a system display, to memory, etc.) at 460.

FIG. 5 shows a block diagram 500 of a device 505 that supports face tone color enhancement in accordance with aspects of the present disclosure. Device 505 may be an example of aspects of a device 205 as described with reference to FIG. 2 or a mobile device 315 as described with reference to FIG. 3. Device 505 may include sensor 510, image processing block 515, and display 560. Each of these components may be in communication with one another (e.g., via one or more buses).

Sensor 510 may include or be an example of a digital imaging sensor for taking photos and video. In some examples, sensor 510 may receive information such as packets, user data, or control information associated with various information channels (e.g., from a transceiver 235 described with reference to FIG. 2). Information may be passed on to other components of the device. Additionally or alternatively, components of device 505 used to communicate data over a wireless (e.g., or wired) link may be in communication with image processing block 515 (e.g., via one or more buses) without passing information through sensor 510.

Image processing block 515 may be an example of aspects of the image processing block 215 described with reference to FIG. 2. Image processing block 515 and/or at least some of its various sub-components may be implemented in hardware, software executed by a processor, firmware, or any combination thereof. If implemented in software executed by a processor, the functions of the image processing block 515 and/or at least some of its various sub-components may be executed by a general-purpose processor, a DSP, an ASIC, an FPGA or other programmable logic device, discrete gate or transistor logic, discrete hardware components, an ISP, a GPU, or any combination thereof designed to perform the functions described in the present disclosure.

Image processing block 515 and/or at least some of its various sub-components may be physically located at various positions, including being distributed such that portions of functions are implemented at different physical locations by one or more physical devices. In some examples, image processing block 515 and/or at least some of its various sub-components may be a separate and distinct component in accordance with various aspects of the present disclosure. In other examples, image processing block 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Image processing block 515 may include input controller 520, feature extraction unit 525, color ratio manager 530, matrix identifier 535, tone adjuster 540, output controller 545, statistics generator 550, and white balance component 555. Each of these modules may communicate, directly or indirectly, with one another (e.g., via one or more buses).

Input controller 520 may receive a raw image from a sensor of the device. For example, input controller 520 may receive a two-dimensional pixel array representing a scene (e.g., digital image 100 described with reference to FIG. 1).

Feature extraction unit 525 may detect a set of regions of pixels corresponding to respective image features in the raw image. Feature extraction unit 525 may identify, for each region of pixels, one or more sections of the raw image containing the each region of pixels. In some cases, detecting the set of regions of pixels corresponding to respective image features in the raw image includes detecting a set of faces in the raw image based on one or more respective facial features associated with each face. Thus, in some cases, feature extraction unit 525 may perform aspects of the operations descried with reference to the region detection component of FIG. 3.

Color ratio manager 530 may compute one or more color ratios for each region of pixels. For example, color ratio manager 530 may compute the one or more color ratios for each region of pixels based on the statistics for the one or more sections of the raw image which contain that region of pixels. In some cases, computing the one or more color ratios for each region of pixels includes computing a respective red-to-green ratio, a respective blue-to-green ratio, or both for each region of pixels.

Matrix identifier 535 may determine a respective CCM for each region of pixels based on the one or more color ratios associated with that region of pixels. In some cases, matrix identifier 535 may determine values for each respective CCM based on the white balance output. In some cases, determining values for each respective CCM based on the white balance output includes identifying a range of color ratios associated with each of a set of template color correction matrices based on the white balance output. For example, matrix identifier 535 may identify, for each region of pixels, a respective template CCM based on a color ratio of the one or more color ratios for that region of pixels falling within the range of color ratios associated with that template CCM. Matrix identifier 535 may determine values for each respective CCM based on the respective template CCM. In some cases, determining the respective CCM for a given region of pixels includes identifying a first template CCM having a first color ratio lower than a corresponding color ratio of the one or more color ratios for the given region of pixels. Matrix identifier 535 may identify a second template CCM having a second color ratio greater than the corresponding color ratio of the one or more color ratios for the given region of pixels. Matrix identifier 535 may interpolate between values of the first template CCM and the second template CCM to generate values of the respective CCM for the given region of pixels.

Tone adjuster 540 may generate a color-corrected image based on an application of the respective CCM to each region of pixels. For example, applying the respective CCM to a given region of pixels may include multiplying the 3×3 CCM by the 3×1 component vector of each pixel to generate a color-corrected (e.g., filtered) 3×1 component vector.

Output controller 545 may output the color-corrected image. For example, output controller 545 may transfer the color-corrected image to a memory component of device 505, to display 560, to a display buffer, etc.

Statistics generator 550 may determine respective statistics for a set of sections of the raw image, where the statistics for a given section indicate one or more representative pixel values for the given section. In some cases, the statistics for the given section indicate an average red component value for the given section, an average blue component value for the given section, an average green component value for the given section, or a combination thereof. In some cases, the set of sections collectively include an entirety of the raw image.

White balance component 555 may identify a white balance output for the raw image based on the statistics. In some cases, white balance component 555 may identify a white balance output for each section of the raw image based at least in part on the statistics.

Display 560 may be an example of display 250 described with reference to FIG. 2. For example, display 560 may be a touchscreen, a LED, a monitor, etc. In some cases, display 560 may be replaced by system memory (e.g., memory 225 described with reference to FIG. 2). That is, in some cases in addition to (or instead of) being displayed by device 505, the color-corrected image may be stored in a memory of device 505.

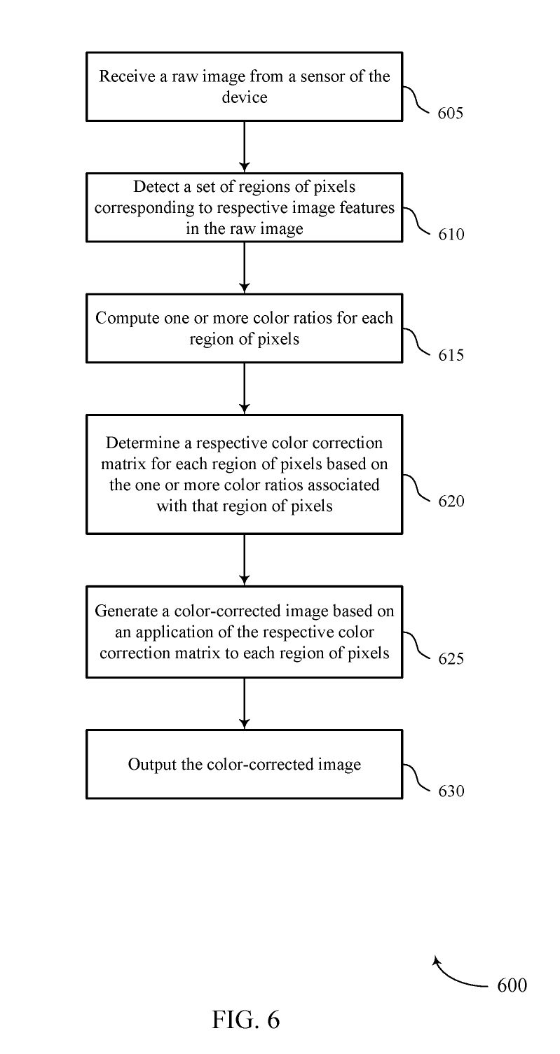

FIG. 6 shows a flowchart illustrating a method 600 for face tone color enhancement in accordance with aspects of the present disclosure. The operations of method 600 may be implemented by a device or its components as described herein. For example, the operations of method 600 may be performed by an image processing block as described with reference to FIGS. 2, 3, and 5. In some examples, a device may execute a set of codes to control the functional elements of the device to perform the functions described below. Additionally or alternatively, the device may perform aspects of the functions described below using special-purpose hardware.

At 605 the device may receive a raw image from a sensor of the device. The operations of 605 may be performed according to the methods described herein. In certain examples, aspects of the operations of 605 may be performed by a input controller as described with reference to FIG. 5.

At 610 the device may detect a plurality of regions of pixels corresponding to respective image features in the raw image. The operations of 610 may be performed according to the methods described herein. In certain examples, aspects of the operations of 610 may be performed by a feature extraction unit as described with reference to FIG. 5.

At 615 the device may compute one or more color ratios for each region of pixels. The operations of 615 may be performed according to the methods described herein. In certain examples, aspects of the operations of 615 may be performed by a color ratio manager as described with reference to FIG. 5.

At 620 the device may determine a respective CCM for each region of pixels based at least in part on the one or more color ratios associated with that region of pixels. The operations of 620 may be performed according to the methods described herein. In certain examples, aspects of the operations of 620 may be performed by a matrix identifier as described with reference to FIG. 5.

At 625 the device may generate a color-corrected image based on an application of the respective CCM to each region of pixels. The operations of 625 may be performed according to the methods described herein. In certain examples, aspects of the operations of 625 may be performed by a tone adjuster as described with reference to FIG. 5.

At 630 the device may output the color-corrected image. The operations of 630 may be performed according to the methods described herein. In certain examples, aspects of the operations of 630 may be performed by a output controller as described with reference to FIG. 5.

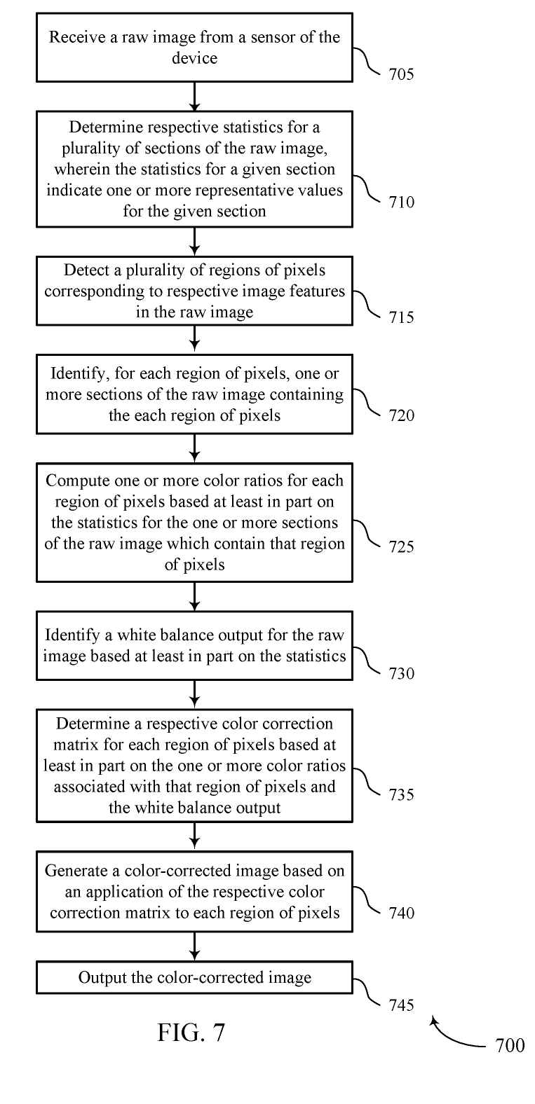

FIG. 7 shows a flowchart illustrating a method 700 for face tone color enhancement in accordance with aspects of the present disclosure. The operations of method 700 may be implemented by a device or its components as described herein. For example, the operations of method 700 may be performed by an image processing block as described with reference to FIGS. 2, 3, and 5. In some examples, a device may execute a set of codes to control the functional elements of the device to perform the functions described below. Additionally or alternatively, the device may perform aspects of the functions described below using special-purpose hardware.

At 705 the device may receive a raw image from a sensor of the device. The operations of 705 may be performed according to the methods described herein. In certain examples, aspects of the operations of 705 may be performed by a input controller as described with reference to FIG. 5.

At 710 the device may determine respective statistics for a plurality of sections of the raw image, wherein the statistics for a given section indicate one or more representative values for the given section. The operations of 710 may be performed according to the methods described herein. In certain examples, aspects of the operations of 710 may be performed by a statistics generator as described with reference to FIG. 5.

At 715 the device may detect a plurality of regions of pixels corresponding to respective image features in the raw image. The operations of 715 may be performed according to the methods described herein. In certain examples, aspects of the operations of 715 may be performed by a feature extraction unit as described with reference to FIG. 5.

At 720 the device may identify, for each region of pixels, one or more sections of the raw image containing the each region of pixels. The operations of 720 may be performed according to the methods described herein. In certain examples, aspects of the operations of 720 may be performed by a feature extraction unit as described with reference to FIG. 5.

At 725 the device may compute one or more color ratios for each region of pixels based at least in part on the statistics for the one or more sections of the raw image which contain that region of pixels. The operations of 725 may be performed according to the methods described herein. In certain examples, aspects of the operations of 725 may be performed by a color ratio manager as described with reference to FIG. 5.

At 730 the device may identify a white balance output for the raw image based at least in part on the statistics. The operations of 730 may be performed according to the methods described herein. In certain examples, aspects of the operations of 730 may be performed by a white balance component as described with reference to FIG. 5.

At 735 the device may determine a respective CCM for each region of pixels based at least in part on the one or more color ratios associated with that region of pixels and the white balance output. The operations of 735 may be performed according to the methods described herein. In certain examples, aspects of the operations of 735 may be performed by a matrix identifier as described with reference to FIG. 5.

At 740 the device may generate a color-corrected image based on an application of the respective CCM to each region of pixels. The operations of 740 may be performed according to the methods described herein. In certain examples, aspects of the operations of 740 may be performed by a tone adjuster as described with reference to FIG. 5.

At 745 the device may output the color-corrected image. The operations of 745 may be performed according to the methods described herein. In certain examples, aspects of the operations of 745 may be performed by an output controller as described with reference to FIG. 5.

It should be noted that the methods described above describe possible implementations, and that the operations and the steps may be rearranged or otherwise modified and that other implementations are possible. Further, aspects from two or more of the methods may be combined. In some cases, one or more operations described above (e.g., with reference to FIGS. 6 and 7) may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for color enhancement, comprising:
a processor;
memory in electronic communication with the processor; and
instructions stored in the memory and executable by the processor to cause the apparatus to:
receive a raw image from a sensor of the apparatus;
detect a plurality of regions of pixels corresponding to respective image features in the raw image;
compute one or more color ratios for each region of pixels;
determine a respective color correction matrix for each region of pixels based at least in part on the one or more color ratios associated with that region of pixels;
generate a color-corrected image based on an application of the respective color correction matrix to each region of pixels; and
output the color-corrected image.

2. The apparatus of claim 1, wherein the instructions to compute the one or more color ratios for each region of pixels are executable by the processor to cause the apparatus to:
determine respective statistics for a plurality of sections of the raw image, wherein the statistics for a given section indicate one or more representative pixel values for the given section;
identify, for each region of pixels, one or more sections of the raw image containing the each region of pixels; and
compute the one or more color ratios for each region of pixels based at least in part on the statistics for the one or more sections of the raw image which contain that region of pixels.

3. The apparatus of claim 2, wherein the instructions to determine the respective color correction matrix for each region of pixels are executable by the processor to cause the apparatus to:
identify a white balance output for the raw image based at least in part on the statistics; and
determine values for each respective color correction matrix based at least in part on the white balance output.

4. The apparatus of claim 3, wherein the instructions to determine values for each respective color correction matrix based at least in part on the white balance output are executable by the processor to cause the apparatus to:
identify a range of color ratios associated with each of a plurality of template color correction matrices based at least in part on the white balance output;
identify, for each region of pixels, a respective template color correction matrix based at least in part on a color ratio of the one or more color ratios for that region of pixels falling within the range of color ratios associated with that template color correction matrix; and
determine values for each respective color correction matrix based at least in part on the respective template color correction matrix.

5. The apparatus of claim 2, wherein the plurality of sections collectively comprise an entirety of the raw image, the statistics for the given section indicating an average red component value for the given section, an average blue component value for the given section, an average green component value for the given section, or a combination thereof.

6. The apparatus of claim 1, wherein the instructions to detect the plurality of regions of pixels corresponding to respective image features in the raw image are executable by the processor to cause the apparatus to:
detect a plurality of faces in the raw image based at least in part on one or more respective facial features associated with each face.

7. The apparatus of claim 1, wherein the instructions to compute the one or more color ratios for each region of pixels are executable by the processor to cause the apparatus to:
compute a respective red-to-green ratio, a respective blue-to-green ratio, or both for each region of pixels.

8. The apparatus of claim 1, wherein the instructions to determine the respective color correction matrix for a given region of pixels are executable by the processor to cause the apparatus to:
identify a first template color correction matrix having a first color ratio lower than a corresponding color ratio of the one or more color ratios for the given region of pixels;
identify a second template color correction matrix having a second color ratio greater than the corresponding color ratio of the one or more color ratios for the given region of pixels; and
interpolate between values of the first template color correction matrix and the second template color correction matrix to generate values of the respective color correction matrix for the given region of pixels.

9. A method for color enhancement at a device, comprising:
receiving a raw image from a sensor of the device;
detecting a plurality of regions of pixels corresponding to respective image features in the raw image;
computing one or more color ratios for each region of pixels;
determining a respective color correction matrix for each region of pixels based at least in part on the one or more color ratios associated with that region of pixels;
generating a color-corrected image based on an application of the respective color correction matrix to each region of pixels; and
outputting the color-corrected image.

10. The method of claim 9, wherein computing the one or more color ratios for each region of pixels comprises:
determining respective statistics for a plurality of sections of the raw image, wherein the statistics for a given section indicate one or more representative pixel values for the given section;
identifying, for each region of pixels, one or more sections of the raw image containing the each region of pixels; and
computing the one or more color ratios for each region of pixels based at least in part on the statistics for the one or more sections of the raw image which contain that region of pixels.

11. The method of claim 10, wherein determining the respective color correction matrix for each region of pixels comprises:
identifying a white balance output for the raw image based at least in part on the statistics; and
determining values for each respective color correction matrix based at least in part on the white balance output.

12. The method of claim 11, wherein determining values for each respective color correction matrix based at least in part on the white balance output comprises:
identifying a range of color ratios associated with each of a plurality of template color correction matrices based at least in part on the white balance output;
identifying, for each region of pixels, a respective template color correction matrix based at least in part on a color ratio of the one or more color ratios for that region of pixels falling within the range of color ratios associated with that template color correction matrix; and
determining values for each respective color correction matrix based at least in part on the respective template color correction matrix.

13. The method of claim 10, wherein the plurality of sections collectively comprise an entirety of the raw image, the statistics for the given section indicating an average red component value for the given section, an average blue component value for the given section, an average green component value for the given section, or a combination thereof.

14. The method of claim 9, wherein detecting the plurality of regions of pixels corresponding to respective image features in the raw image comprises:
detecting a plurality of faces in the raw image based at least in part on one or more respective facial features associated with each face.

15. The method of claim 9, wherein computing the one or more color ratios for each region of pixels comprises:
computing a respective red-to-green ratio, a respective blue-to-green ratio, or both for each region of pixels.

16. The method of claim 9, wherein determining the respective color correction matrix for a given region of pixels comprises:
identifying a first template color correction matrix having a first color ratio lower than a corresponding color ratio of the one or more color ratios for the given region of pixels;
identifying a second template color correction matrix having a second color ratio greater than the corresponding color ratio of the one or more color ratios for the given region of pixels; and
interpolating between values of the first template color correction matrix and the second template color correction matrix to generate values of the respective color correction matrix for the given region of pixels.

17. A non-transitory computer-readable medium storing code for color enhancement, the code comprising instructions executable by a processor to:
receive a raw image from a sensor of a device;
detect a plurality of regions of pixels corresponding to respective image features in the raw image;
compute one or more color ratios for each region of pixels;
determine a respective color correction matrix for each region of pixels based at least in part on the one or more color ratios associated with that region of pixels;
generate a color-corrected image based on an application of the respective color correction matrix to each region of pixels; and
output the color-corrected image.

18. The non-transitory computer-readable medium of claim 17, wherein the instructions to compute the one or more color ratios for each region of pixels are executable by the processor to:
determine respective statistics for a plurality of sections of the raw image, wherein the statistics for a given section indicate one or more representative pixel values for the given section;
identify, for each region of pixels, one or more sections of the raw image containing the each region of pixels; and
compute the one or more color ratios for each region of pixels based at least in part on the statistics for the one or more sections of the raw image which contain that region of pixels.

19. The non-transitory computer-readable medium of claim 18, wherein the instructions to determine the respective color correction matrix for each region of pixels are executable by the processor to:
identify a white balance output for the raw image based at least in part on the statistics; and
determine values for each respective color correction matrix based at least in part on the white balance output.

20. The non-transitory computer-readable medium of claim 17, wherein the instructions to detect the plurality of regions of pixels corresponding to respective image features in the raw image are executable by the processor to:
detect a plurality of faces in the raw image based at least in part on one or more respective facial features associated with each face.
